(19) United States
(12) Patent Application Publication
(10) Pub. No.: US 2011/0116664 A1
(43) Pub. Date: May 19, 2011

(54) MAGNETOSTRICTIVE ACTUATOR AND SPEAKER AND DEVICE USING SAID MAGNETOSTRICTIVE ACTUATOR

(75) Inventors: Kazuma Fujioka, Mie (JP); Takahumi Yuasa, Mie (JP); Teruo Doi, Mie (JP)

(73) Assignee: Panasonic Corporation, Osaka (JP)

(21) Appl. No.: 13/002,680

(22) PCT Filed: Aug. 28, 2009
(86) PCT No.: PCT/JP2009/004194

§ 371 Date: Jan. 5, 2011

(30) Foreign Application Priority Data
Sep. 10, 2008 (JP) 2008-231722
Sep. 26, 2008 (JP) 2008-247841
Oct. 10, 2008 (JP) 2008-263784

(51) Int. Cl. H04R 15/00

(52) U.S. Cl. 381/190

(57) ABSTRACT

A magnetostrictive actuator includes a magnetostrictive element extending along a central axis, a movable section displaced in response to a change of a shape of the magnetostrictive element, a voice coil wound about the magnetostrictive element, a magnet surrounding the magnetostrictive element and the voice coil, a lower yoke having an upper surface coupled to a lower surface of the magnet and a lower surface of the magnetostrictive element, an upper yoke having a lower surface of the upper yoke being coupled to an upper surface of the magnet and an inside surface of the upper yoke facing the outside surface of the movable section across a clearance, and an elastic member disposed in the clearance. The elastic member joined to an outside surface of the movable section and the inside surface of the upper yoke. This magnetostrictive actuator has a low-profile structure, suppresses undesired vibration, and exhibits preferable linearity.

### TECHNICAL FIELD

The present invention relates to a magnetostrictive actuator, and also relates to a loudspeaker and a device using the actuator.

### BACKGROUND ART

FIG. 29 is a sectional view showing conventional magnetostrictive actuator 5001 described in Patent Literature 1. Bobbin 3 about which voice coil 2 is wound is disposed at the periphery of magnetostrictive element 1. Magnetostrictive element 1 has upper magnet 4 and lower magnet 5 at the upper end and lower end thereof, respectively. Movable section 6 is joined to the upper surface of upper magnet 4. Upper yoke 7 is joined to the periphery of movable section 6. Lower yoke 8 is joined to the lower surface of lower magnet 5. Upper yoke 7 and lower yoke 8 surround the periphery of voice coil 2. Flange 9 is formed along the bottom periphery of movable section 6. Cushion 2010 is sandwiched between flange 9 and upper yoke 7 in a vibrating direction of movable section 6.

An operation of conventional magnetostrictive actuator 5001 will be described. Upper magnet 4, lower magnet 5, movable section 6, upper yoke 7, and lower yoke 8 constitute closed magnet circuit 11 that provides magnetostrictive element 1 with a bias magnetic field. Movable section 6, upper yoke 7, and lower yoke 8 are made of magnetic material, such as iron.

Voice coil 2 produces a magnetic field that changes in response to a signal input thereto. According to the change in the magnetic field, magnetostrictive element 1 has a change in dimensions, which transmits outward as vibration via upper magnet 4 and movable section 6. Cushion 2010 made of an elastic body suppresses undesired vibration of movable section 6 and stabilizes a performance of actuator 5001.

Cushion 2010 disposed between upper yoke 7 and movable section 6, needs to have a space with a predetermined thickness in a vibrating direction of movable section 6. This prevents actuator 5001 from being thin. Besides, it is necessary to have a clearance between the outside surface of movable section 6 and the inside surface of upper yoke 7 to vibrate movable section 6. If moisture or a foreign matter enters in the clearance, actuator 5001 can degrade its reliability.

Upper magnet 4 and lower magnet 5 for producing a bias magnetic field are disposed at both ends of magnetostrictive element 1. The structure, however, prevents magnetic flux from sufficiently passing through the center of magnetostrictive element 1 due to low magnetic permeability of magnetostrictive element 1. That is, magnetostrictive element 1 cannot provide uniform density distribution of magnetic flux, so that actuator 5001 has poor linearity.

In recent years, home electrical appliances and electronic devices with audio guidance functions have been increasing in terms of promoting universal design. Accordingly, it has been necessary that built-in loudspeakers for reproducing audio guidance should be not only formed into compact but also formed into a structure being resistant to heat, moisture, and dust, which home electrical appliances are often subject to.

FIG. 30 is a sectional view showing conventional small loudspeaker 100 for reproducing audio guidance described in Patent Literature 2. Loudspeaker 100 includes frame 101, yoke 102 mounted on frame 101, magnet 103 joined to yoke 102, plate 104 joined to the upper surface of magnet 103, bobbin 105 disposed in a magnetic gap between yoke 102 and plate 104, voice coil 106 wound on bobbin 105, damper 107 joined to frame 101 and bobbin 105, diaphragm 108 joined to bobbin 105, edge 109 joined to diaphragm 108 and frame 101, and dust cap 110 joined to diaphragm 108.

In order to increase waterproof performance of loudspeaker 100, diaphragm 108 and dust cap 110 have surface treatment with fluorine resin.

Conventional loudspeaker 100 often contains cloth or paper as material. In the structure having such materials, increase in waterproof performance can be attained by the surface treatment with fluorine resin, but increase in heat proof performance cannot be expected. Besides, such structured diaphragm components cannot bear long-term use because of aging of cloth and paper. Further, if dust enters into the magnetic gap, it can cause noise. In consideration of the above problems, the conventional structure has poor durability as a loudspeaker built in a home electrical appliance that is often exposed to moisture, heat, or dust.

As a device has small size and small thickness to meet the recent trend, a built-in magnetostrictive actuator also needs to be thinner.

FIG. 31 is a sectional view showing conventional magnetostrictive actuator 1100 described in Patent Literature 3. Magnetostrictive actuator 1100 includes magnetostrictive element 1101, bobbin 1102, voice coil 1103, magnets 1104A and 1104B, vibration-transmitting member 1105, yoke 1106 that forms a magnetic circuit, spring 1107, case 1108, screw 1109, and nut 1110. Magnetostrictive actuator 1100 is fixed on wall surface 1111.

Magnetostrictive element 1101 and bobbin 1102 are arranged concentrically. Voice coil 1103 is wound around bobbin 1102. Magnet 1104A is attached to the bottom of magnetostrictive element 1101 and magnet 1104B is attached to the top of it. Magnet 1104B is joined to vibration-transmitting member 1105. Vibration-transmitting member 1105 has a projection at its center portion and a peripheral section around the projection. One end of spring 1107 is joined to the peripheral section of vibration-transmitting member 1105, and the other end is joined to yoke 1106 that surrounds the periphery of voice coil 1103. Yoke 1106 transmits magnetic flux to magnetostrictive element 1101. Yoke 1106 has an opening. The central projection of vibration-transmitting member 1105 protrudes through the opening, and the end of the projection is joined to wall surface 1111. Case 1108 is adapted to be joined to the bottom of yoke 1106 and fixed to wall surface 1111 with screw 1109 and nut 1110, so that magnetostrictive actuator 1100 is fixed to wall surface 1111.

Spring 1107 applies an appropriate amount of compressive stress to magnetostrictive element 1101, which increases the magnetostrictive amount of element 1101, contributing to improvement in performance. Case 1108 securely holds magnetostrictive actuator 1100 and protects the actuator from moisture and dust. Spring 1107 and case 1108 are formed as separate components, preventing decrease in parts and size of magnetostrictive actuator 1100. In particular, home electrical appliances, such as a rice cooker and a washing machine, need a small device. To meet the requirement, conventional magnetostrictive element 1101 has to be shortened in length, which degrades performance of magnetostrictive actuator 1100.

### PATENT LITERATURE

Patent Literature 1: Japanese Patent Laid-Open Publication No. 2006-311255

Patent Literature 2: Japanese Patent Laid-Open Publication No. 2007-60725

Patent Literature 3: Japanese Patent Laid-Open Publication No. 2005-303462

### SUMMARY OF THE INVENTION

A magnetostrictive actuator includes a magnetostrictive element extending along a central axis, a movable section displaced in response to a change of a shape of the magnetostrictive element, a voice coil wound about the magnetostrictive element, a magnet surrounding the magnetostrictive element and the voice coil, a lower yoke having an upper surface coupled to a lower surface of the magnet and a lower surface of the magnetostrictive element, an upper yoke having a lower surface of the upper yoke being coupled to an upper surface of the magnet and an inside surface of the upper yoke facing the outside surface of the movable section across a clearance, and an elastic member disposed in the clearance. The elastic member joined to an outside surface of the movable section and the inside surface of the upper yoke.

This magnetostrictive actuator has a low-profile structure, suppresses undesired vibration, and exhibits preferable linearity.

### BRIEF DESCRIPTION OF THE DRAWINGS

FIG. 1A is a perspective view showing a magnetostrictive actuator in accordance with a first exemplary embodiment of the present invention.

FIG. 1B is a sectional view showing the magnetostrictive actuator in accordance with the first embodiment.

FIG. 2 is a sectional view showing a magnetostrictive actuator in accordance with a second exemplary embodiment of the invention.

FIG. 3A is a sectional view showing a magnetostrictive actuator in accordance with a third exemplary embodiment of the invention.

FIG. 3B is a sectional view showing another magnetostrictive actuator in accordance with the third embodiment.

FIG. 4 is a sectional view showing a magnetostrictive actuator in accordance with a fourth exemplary embodiment of the invention.

FIG. 5 is a sectional view showing a magnetostrictive actuator in accordance with a fifth exemplary embodiment of the invention.

FIG. 6 is a sectional view showing a magnetostrictive actuator in accordance with a sixth exemplary embodiment of the invention.

FIG. 7 is a sectional view showing a magnetostrictive actuator in accordance with a seventh exemplary embodiment of the invention.

FIG. 8 is a perspective view showing a magnetostrictive loudspeaker in accordance with an eighth exemplary embodiment of the invention.

FIG. 9 is a side view showing the magnetostrictive loudspeaker shown in FIG. 8.

FIG. 10 is a sectional view of the magnetostrictive loudspeaker along line 10-10 shown in FIG. 8.

FIG. 11A is a sectional view showing the magnetostrictive loudspeaker in accordance with the eighth embodiment.

FIG. 11B is a sectional view showing the magnetostrictive loudspeaker in accordance with the eighth embodiment.

FIG. 12 is a sectional view showing a magnetostrictive loudspeaker in accordance with a ninth exemplary embodiment of the invention.

FIG. 13 is a top view showing a magnetostrictive loudspeaker in accordance with a tenth exemplary embodiment of the invention.

FIG. 14 is a sectional view of the magnetostrictive loudspeaker along line 14-14 shown in FIG. 13.

FIG. 15 is a sectional view showing a magnetostrictive loudspeaker in accordance with an eleventh exemplary embodiment of the invention.

FIG. 16 is a sectional view showing a magnetostrictive loudspeaker in accordance with a twelfth exemplary embodiment of the invention.

FIG. 17 is a perspective view showing a magnetostrictive actuator in accordance with a thirteenth exemplary embodiment of the invention.

FIG. 18 is a plan view showing the magnetostrictive actuator in accordance with the thirteenth embodiment.

FIG. 19 is a side view showing the magnetostrictive actuator in accordance with the thirteenth embodiment.

FIG. 20 is a sectional view of the magnetostrictive actuator along line 20-20 shown in FIG. 18.

FIG. 21A is a sectional view showing the magnetostrictive actuator in accordance with the thirteenth embodiment.

FIG. 21B is a sectional view showing the magnetostrictive actuator in accordance with the thirteenth embodiment.

FIG. 22 is a perspective view showing another magnetostrictive actuator in accordance with the thirteenth embodiment.

FIG. 23 is a sectional view showing a magnetostrictive actuator in accordance with a fourteenth exemplary embodiment of the invention.

FIG. 24 is a plan view showing a magnetostrictive actuator in accordance with a fifteenth exemplary embodiment of the invention.

FIG. 25 is a sectional view of the magnetostrictive actuator along line 25-25 shown in FIG. 24.

FIG. 26 is a sectional view showing a magnetostrictive actuator in accordance with a sixteenth exemplary embodiment of the invention.

FIG. 27 is a sectional view showing a magnetostrictive actuator in accordance with a seventeenth exemplary embodiment of the invention.

FIG. 28A is a sectional view showing a device including a magnetostrictive loudspeaker in accordance with an eighteenth exemplary embodiment of the invention.

FIG. 28B is a sectional view showing another device including the magnetostrictive loudspeaker in accordance with the eighteenth embodiment.

FIG. 29 is a sectional view showing a conventional magnetostrictive actuator.

FIG. 30 is a sectional view showing a conventional loudspeaker.

FIG. 31 is a sectional view showing a conventional magnetostrictive actuator.

### DETAILED DESCRIPTION OF PREFERRED EMBODIMENTS

### Exemplary Embodiment 1

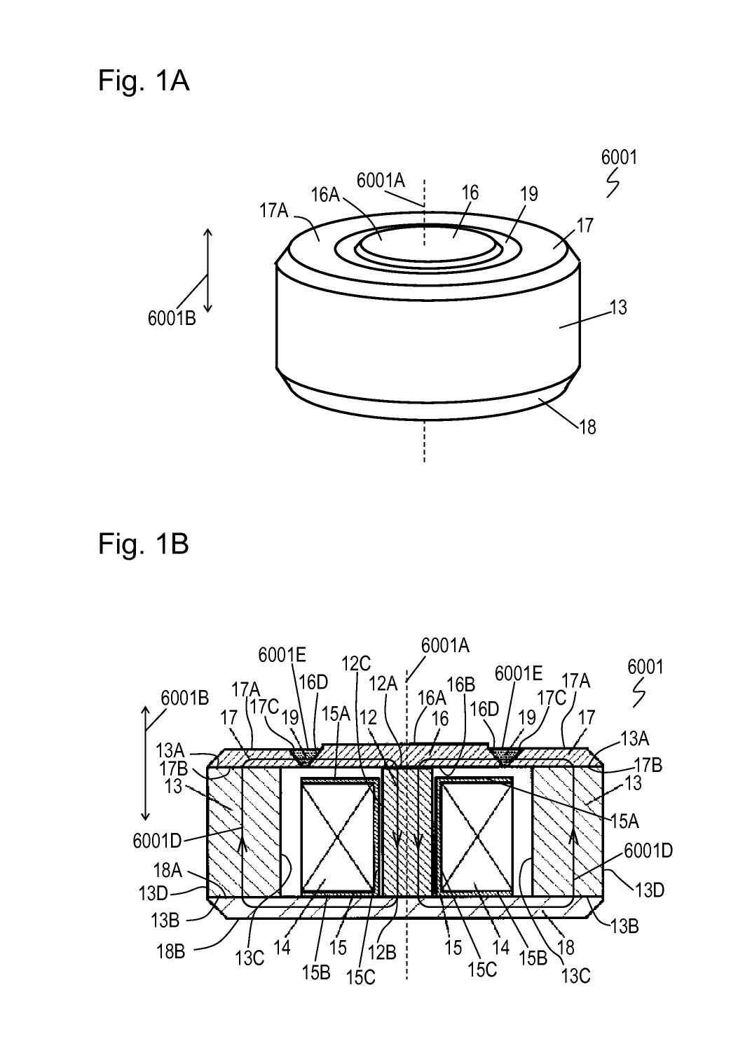

FIGS. 1A and 1B are a perspective view and a sectional view of magnetostrictive actuator 6001 in accordance with a first exemplary embodiment of the present invention, respectively. Magnetostrictive element 12 extends along central axis 6001A in axial direction 6001B, and has upper surface 12A and lower surface 12B opposite to each other in the direction of central axis 6001A and side surface 12C joined to the upper and the lower surfaces in between. Side surface 12C extends in axial direction 6001B and surrounds central axis 6001A. Bobbin 15 surrounds side surface 12C of magnetostrictive element 12. Voice coil 14 is wound on bobbin 15 about central axis 6001A. Magnet 13 extends in axial direction 6001B, and has a tubular shape surrounding magnetostrictive element 12. In the first embodiment, magnet 13 has a cylindrical shape extending along central axis 6001A. Magnet 13 has upper surface 13A and lower surface 13B opposite to each other in the direction of central axis 6001A, inside surface 13C joined to the upper and the lower surfaces in between, and outside surface 13D joined to the upper and the lower surfaces in between. Inside surface 13C faces voice coil 14. Inside surface 13C and outside surface 13D extend in axial direction 6001B. In the first embodiment, magnetostrictive element 12 has a length identical to that of magnet 13 in axial direction 6001B.

Bobbin 15 is made of nonmagnetic material, such as resin. Bobbin 15 has tubular part 15C through which magnetostrictive element 12 is disposed, upper flange 15A protruding from the upper end of tubular part 15C, and lower flange 15B protruding from the lower end of tubular part 15C. Lower flange 15B is coupled to upper surface 18A of lower yoke 18. The inside surface of tubular part 15C does not necessarily contact magnetostrictive element 12. Voice coil 14 is wound on about tubular part 15C.

Movable section 16 has lower surface 16B joined to upper surface 12A of magnetostrictive element 12, upper surface 16A opposite to lower surface 16B, and outside surface 16D opens in a direction removed away from central axis 6001A. In response to a change in a shape of magnetostrictive element 12, movable section 16 is displaced and transmits the change of the shape to the outside. Upper yoke 17 has lower surface 17B joined to upper surface 13A of magnet 13, upper surface 17A opposite to lower surface 17B, and inside surface 17C facing outside surface 16D of movable section 16. Lower yoke 18 has upper surface 18A joined to lower surface 12B of magnetostrictive element 12 and lower surface 13B of magnet 13. Movable section 16, upper yoke 17, and lower yoke 18 which are made of magnetic material, such as iron, constitute a yoke. Magnetostrictive element 12, movable section 16, magnet 13, upper yoke 17, and lower yoke 18 constitute closed magnetic circuit 6001D. In closed magnetic circuit 6001D, magnet 13 provides magnetostrictive element 12 with a bias magnetic field. Clearance 6001E between outside surface 16D of movable section 16 and inside surface 17C of upper yoke 17 is filled with adhesive 19 made of elastic material. That is, adhesive 19 contacts outside surface 16D of movable section 16 and inside surface 17C of upper yoke 17. Each of respective upper sections of outside surface 16D of movable section 16 and inside surface 17C of upper yoke 17 undergo trimming. Clearance 6001E flares upwardly, i.e. flares toward the outside of actuator 6001.

Movable section 16 and upper yoke 17 are disposed on the same plane, allowing actuator 6001 to have a low-profile structure. Adhesive 19 seals up clearance 6001E, protecting the inside of actuator 6001 surrounded by yokes 17 and 18 and movable section 16 from entry of moisture and a foreign matter. This structure protects the actuator from product degradation caused by moisture and a foreign matter.

An operation of magnetostrictive actuator 6001 will be described.

Magnetostrictive element 12 is made of ferromagnetic material, such as nickel, cobalt, iron, or alloy mainly containing these materials. In particular, magnetostrictive element 12 is preferably made of a super magnetic material of an alloy of iron and rare earth element, such as terbium or dysprosium. Voice coil 14 generates a magnetic field with an alternating-current (AC) current that flows through the coil. Affected by the magnetic field in axial direction 6001B, magnetostrictive element 12 has a change in shape and causes movable section 16 to vibrate. At this moment, elastic adhesive 19 contacting outside surface 16D of movable section 16 functions as a damper for suppressing undesired vibration of movable section 16, thereby stabling a performance of actuator 6001.

Magnetostrictive actuator 6001 can structure a loudspeaker in a manner that upper surface 16A of movable section 16 is attached to vibrating body 6001F, such as a panel. Receiving vibration transmitted from movable section 16, vibrating body 6001F vibrates, and sound is produced according to the AC current that flows through voice coil 14. In the structure above, upper surface 16A of movable section 16 is coupled to the lower surface of the vibrating panel (vibrating body).

Magnetostrictive element 12 and magnet 13 having thicknesses (i.e. lengths in axial direction 6001B) identical to each other constitutes closed magnetic circuit 6001D; specifically, the structure allows magnetic flux to converge at the center of voice coil 14 (i.e. the center of magnetostrictive element 12), even if magnetostrictive element 12 is made of a material with low magnetic permeability. That is, magnetic flux uniformly flows through magnetostrictive element 12, with variations in density of magnetic flux suppressed. As a result, actuator 6001 provides preferable linearity.

Preferably used for elastic adhesive 19 is a silicone-rubber-based adhesive which has a viscosity before hardened and has elasticity after hardened. The outwardly flaring shape of clearance 6001E allows adhesive 19 to easily apply thereto. Besides, the viscosity of adhesive 19 exhibited before hardened prevents adhesive 19 from spreading over places not to be adhered.

Upon being compressed with a compression load, magnetostrictive element 12 has not only the magnetic permeability changed but also the magnetostrictive amount thereof change. Considering above, actuator 6001 may have a structure for applying a proper compression load to magnetostrictive element 12 or the weight of actuator 6001 itself may be applied as a compression load to magnetostrictive element 12. According to the first embodiment, actuator 6001 applies a compression load from outside to magnetostrictive element 12. That is, actuator 6001 is required to have an additional structure for applying the compression load, consequently having a low profile.

### Exemplary Embodiment 2

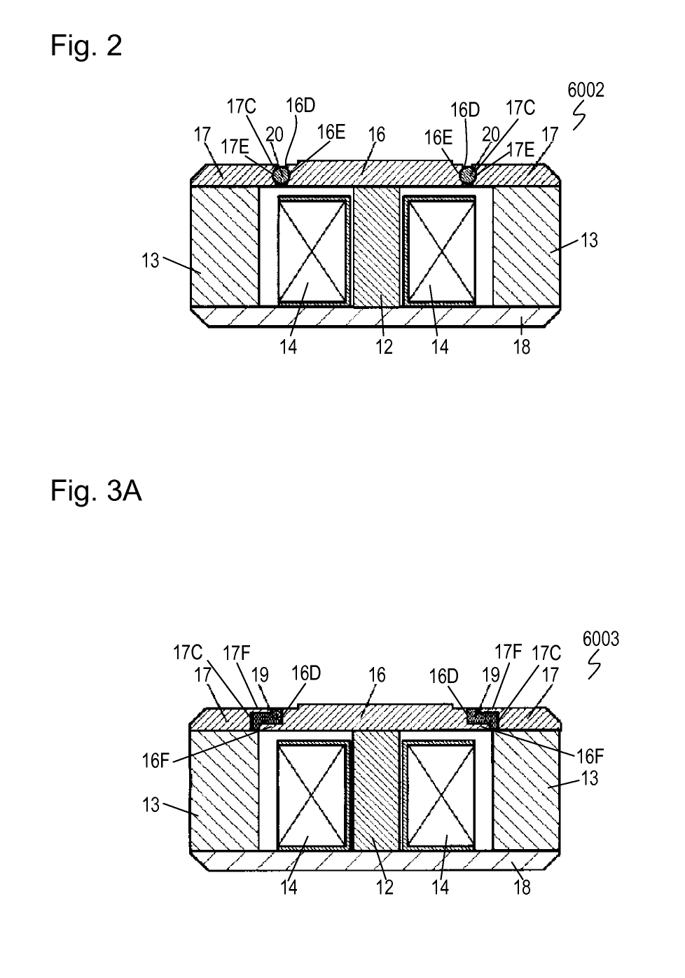

FIG. 2 is a sectional view showing magnetostrictive actuator 6002 in accordance with a second exemplary embodiment of the present invention. In FIG. 2, like parts are identified by the same reference marks as magnetostrictive actuator 6001 according to the first embodiment shown in FIGS. 1A and 1B.

Magnetostrictive actuator 6002 of the second embodiment includes elastic O-ring 20, instead of adhesive 19 used in actuator 6001 of the first embodiment. O-ring 20 is made of an elastic material, such as silicone rubber, and is disposed in clearance 6001E. In the second embodiment, although O-ring 20 is fitted in groove 16E formed in outside surface 16D of movable section 16 and in groove 17E formed in inside surface 17C of upper yoke 17, it can be held by a single groove; one of grooves 16E and 17E. In this case, the other of grooves 16E and 17E is not necessarily provided in movable section 16 or upper yoke 17.

The structure positions movable section 16 stably. Like adhesive 19 of magnetostrictive actuator 6001 of the first embodiment, elastic O-ring 20 serves as a controller for suppressing undesired vibration of movable section 16, allowing actuator 6001 to work stably. Besides, desired vibration control can be attained by optimal material selection of O-ring 20. That is, performance control of actuator 6002 can be obtained according to difference in material properties of a component to be vibrated.

### Exemplary Embodiment 3

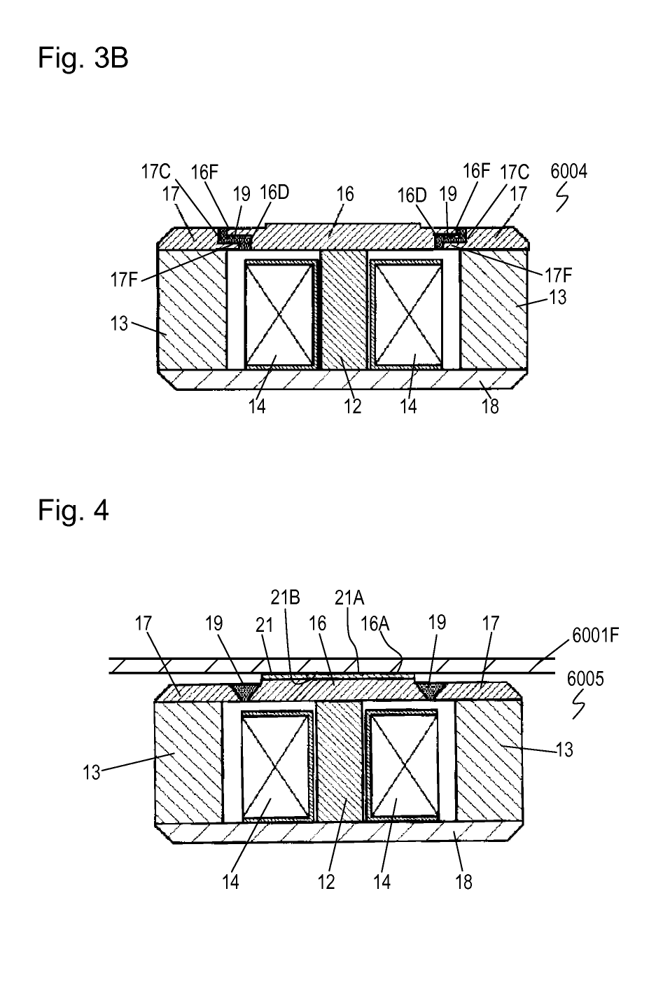

FIG. 3A is a sectional view showing magnetostrictive actuator 6003 in accordance with a third exemplary embodiment of the present invention. In FIG. 3A, like parts are identified by the same reference marks as magnetostrictive actuator 6001 of the first embodiment shown in FIGS. 1A and 1B.

In magnetostrictive actuator 6003 of the third embodiment, movable section 16 includes flange 16F protruding from the lower end of outside surface 16D, while upper yoke 17 includes flange 17F protruding from the upper end of inside surface 17C. Flange 16F is located away from inside surface 17C of upper yoke 17. Similarly, flange 17F is located away from outside surface 16D of movable section 16. Clearance 6001E is surrounded by inside surface 17C of upper yoke 17, outside surface 16D of movable section 16, flange 16F, and flange 17F. Adhesive 19 made of elastic material is applied to clearance 6001E and contacts inside surface 17C of upper yoke 17, outside surface 16D of movable section 16, flange 16F, and flange 17F.

In magnetostrictive actuator 6003, clearance 6001E to be filled with adhesive 19 is surrounded from four directions by inside surface 17C of upper yoke 17, outside surface 16D of movable section 16, flange 16F, and flange 17F. That is, adhesive 19 of the third embodiment is applied to clearance 6001E in larger amount and contacts upper yoke 17 and movable section 16 in larger area than adhesive 19 used for magnetostrictive actuator 6001 of the first embodiment shown in FIG. 1B. This structure provides actuator 6003 with larger strength.

FIG. 3B is a sectional view showing another magnetostrictive actuator 6004 in accordance with the third embodiment. In FIG. 3B, like parts are identified by the same reference marks as magnetostrictive actuator 6003 shown in FIG. 3A.

In magnetostrictive actuator 6004, flange 16F protrudes from the upper end of outside surface 16D of movable section 16 toward inside surface 17C of upper yoke 17, but it is located away from inside surface 17C. Similarly, flange 17F protrudes from the lower end of inside surface 17C of upper yoke 17 toward outside surface 16D of movable section 16, but it is located away from outside surface 16D. Clearance 6001E of magnetostrictive actuator 6004 can be filled with adhesive 19 as large as the amount used in magnetostrictive actuator 6003 shown in FIG. 3A. Magnetostrictive actuator 6004 offers the effect similar to actuator 6003.

### Exemplary Embodiment 4

FIG. 4 is a sectional view showing magnetostrictive actuator 6005 in accordance with a fourth exemplary embodiment of the present invention. In FIG. 4, like parts are identified by the same reference marks as magnetostrictive actuator 6001 of the first embodiment shown in FIGS. 1A and 1B.

Magnetostrictive actuator 6005 has a structure where vibration-transmitting member 21 is joined to upper surface 16A of movable section 16 of actuator 6001 of FIG. 1B in the first embodiment. Vibration-transmitting member 21 differs from movable section 16 in material properties.

When magnetostrictive actuator 6005 is used for acoustic equipment, such as flat panel loudspeakers, vibration-transmitting member 21 is joined to vibrating body 6001F, such as a panel. Selecting material of vibration-transmitting member 21 to agree with the material or the size of vibrating body 6001F provides sound reproduction suitable for vibrating body 6001F.

Vibration-transmitting member 21 is preferably made of nonmagnetic material, such as aluminum, resin, or rubber.

Vibration-transmitting member 21 is attached to magnetostrictive actuator 6001 of first embodiment, but it is not limited thereto; actuator 6002 of the second embodiment and actuators 6003 and 6004 of embodiment 3 may further include vibration-transmitting member 21. In that case, the actuators also offer the effect similar to actuator 6005.

### Exemplary Embodiment 5

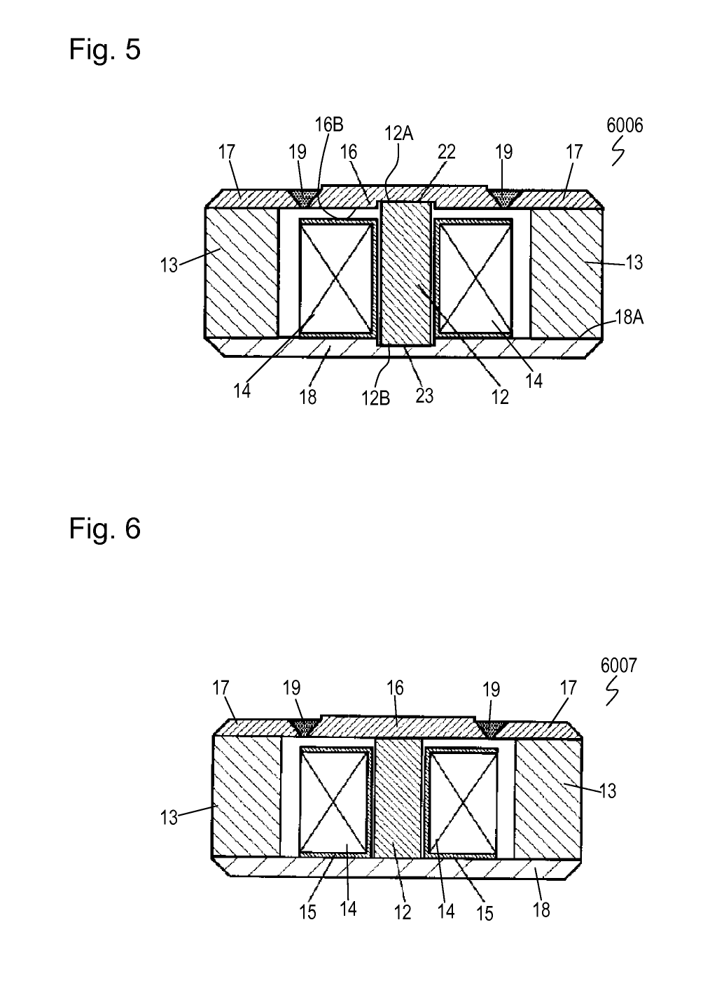

FIG. 5 is a sectional view showing magnetostrictive actuator 6006 in accordance with a fifth exemplary embodiment of the present invention. In FIG. 5, like parts are identified by the same reference marks as magnetostrictive actuator 6001 of the first embodiment shown in FIGS. 1A and 1B.

In magnetostrictive actuator 6006, lower surface 16B of movable section 16 has recess 22 therein that upper surface 12A of magnetostrictive element 12 is fitted in. Similarly, upper surface 18A of lower yoke 18 has recess 23 therein that lower surface 12B of element 12 is fitted in. Recess 22 has a shape conforming to upper surface 12A of element 12 and recess 23 has a shape conforming to lower surface 12B of element 12. The structure allows actuator 6006 to be thinner, hence positioning magnetostrictive element 12, movable section 16, and lower yoke 18 easily.

Magnetostrictive actuators 6001 to 6005 of the first to fourth embodiments may have the structure above. In the case that recesses 22 and 23 are additionally formed in lower surface 16B of movable section 16 and in upper surface 18A of lower yoke 18, respectively, these actuators offer the effect similar to actuator 6006.

### Exemplary Embodiment 6

FIG. 6 is a sectional view showing magnetostrictive actuator 6007 in accordance with a sixth exemplary embodiment of the present invention. In FIG. 6, like parts are identified by the same reference marks as magnetostrictive actuator 6001 of the first embodiment shown in FIGS. 1A and 1B.

In magnetostrictive actuator 6007 of the sixth embodiment, magnetostrictive element 12 is integrally formed with bobbin 15 by insert molding. The structure reduces man-hours for assembling actuator 6007. Besides, this integral structure prevents noises caused by contacting of magnetostrictive element 12 with bobbin 15.

Magnetostrictive actuators 6001 to 6006 of the first to fifth embodiments may have the structure above. In the case that magnetostrictive element 12 is integrally formed with bobbin 15 by insert molding, these actuators offer the effect similar to actuator 6007.

### Exemplary Embodiment 7

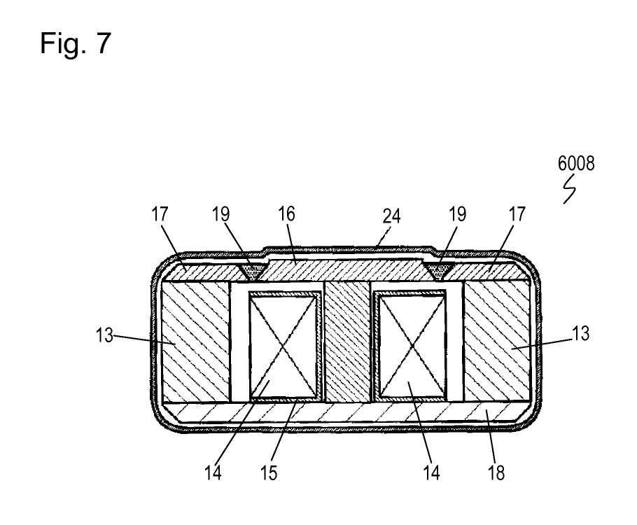

FIG. 7 is a sectional view showing magnetostrictive actuator 6008 in accordance with a seventh exemplary embodiment of the present invention. In FIG. 7, like parts are identified by the same reference marks as magnetostrictive actuator 6001 of the first embodiment shown in FIGS. 1A and 1B.

In addition to the structure of actuator 6001 of the first embodiment shown in FIG. 1B, actuator 6008 further includes resin film 24. Resin film 24 entirely covers movable section 16, adhesive 19, upper yoke 17, magnet 13, and lower yoke 18 to seal them up. The structure covered with resin film 24 improves resistance to water and dust, allowing actuator 6008 to reproduce sound in a broadened range of usage. That is, the structure of actuator 6008 enables devices working under a harsh environment, such as cars and home appliances, to have audio guidance functions.

The material preferably employed for resin film 24 is a resin, such as polyphenylene sulfide (PPS), having high resistance to heat and moderate flexibility.

In the case that magnetostrictive actuators 6002 to 6007 of the second to sixth embodiments include resin film 24, these actuators offer the effect similar to actuator 6008.

### Exemplary Embodiment 8

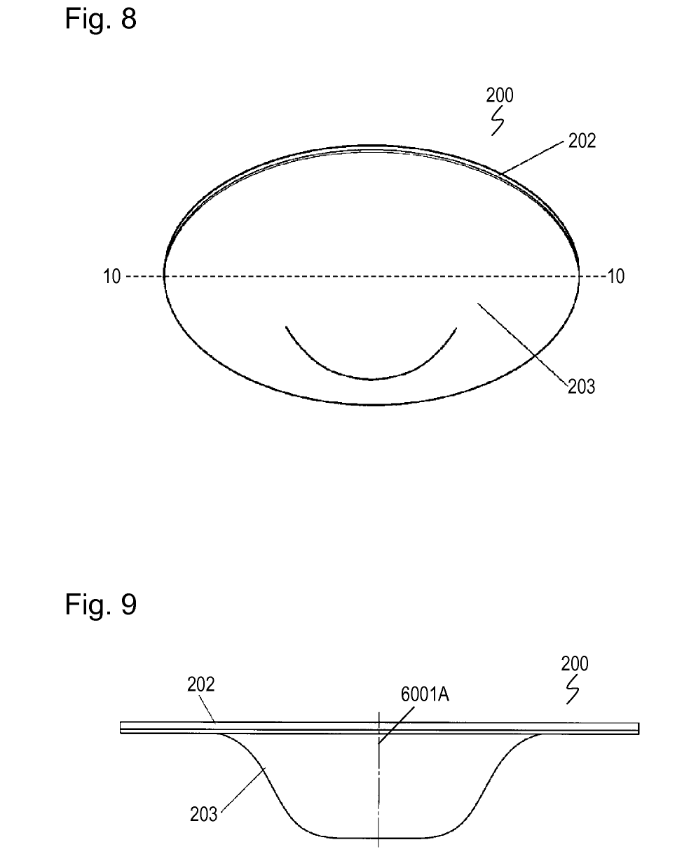

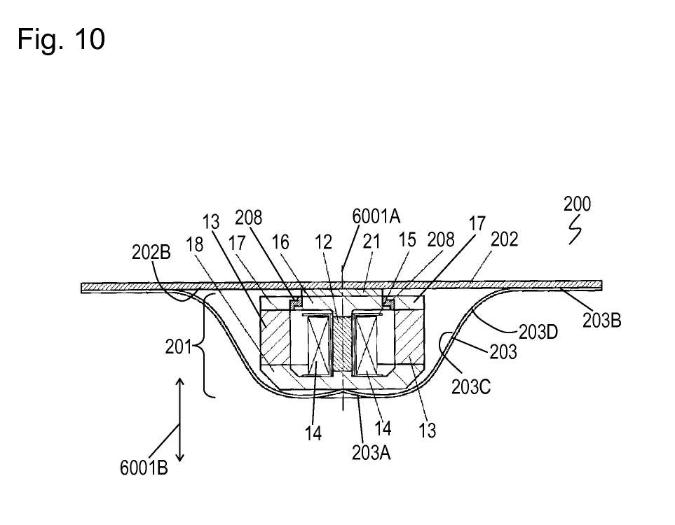

FIG. 8 is a perspective view showing magnetostrictive loudspeaker 200 in accordance with an eighth exemplary embodiment of the present invention. FIG. 9 is a side view showing magnetostrictive loudspeaker 200. FIG. 10 is a sectional view of magnetostrictive loudspeaker 200 along line 10-10 shown in FIG. 8.

Magnetostrictive loudspeaker 200 includes magnetostrictive actuator 201, diaphragm 202, and plate spring 203 as an elastic body. Both of diaphragm 202 and plate spring 203 cover magnetostrictive actuator 201 with a pressure. Magnetostrictive actuator 201 is made of resin (e.g. elastomer), magnet, and magnetic material (e.g. iron). Diaphragm 202 is, for example, a flat diaphragm, and made of a hard resin or metal so as to withstand long-term use under domestic environment. Although plate spring 203 is employed for the elastic body in the eighth embodiment, it is not limited thereto. Instead of a plate spring, rubber or other elastic materials may be used.

As is shown in FIG. 10, magnetostrictive actuator 201 is any one of actuators 6001 to 6008 of the first to seventh embodiments. Magnetostrictive actuator 201 of magnetostrictive loudspeaker 200 of the eighth embodiment has a structure similar to that of actuator 6003 of the third embodiment shown in FIG. 3.

Instead of adhesive 19 as an elastic member of actuator 6003 shown in FIG. 3A, actuator 201 includes elastic member 208 for absorbing vibration. Elastic member 208 is made of resin, such as ring-shaped rubber or a spring that absorbs vibration. Elastic member 208 suppresses undesired vibration of movable section 16, and therefore magnetostrictive loudspeaker 200 vibrates with fidelity according to an AC current supplied into voice coil 14. Vibration-transmitting member 21 is disposed on upper surface 16A of movable section 16. Upper surface 21A of vibration-transmitting member 21 is coupled to lower surface 202B of diaphragm 202. That is, upper surface 16A of movable section 16 is coupled to diaphragm 202 via vibration-transmitting member 21. Receiving vibration produced in movable section 16 of actuator 201, diaphragm 202 converts it into sound. Vibration-transmitting member 21 is made of resin or metal that conforms to the material of diaphragm 202 and serves as a controller of sound quality.

Outside surface 16D of movable section 16 is coupled to inside surface 208C of elastic member 208. Upper yoke 17 holds movable section 16 via elastic member 208 so that movable section 16 is located at the center in a lateral direction.

As movable section 16 has flange 16F and upper yoke 17 has flange 17F, elastic member 208 has a wide contact area with movable section 16 and upper yoke 17, enhancing joint strength between them.

Diaphragm 202 has a flat plate shape. In the eighth embodiment 8, diaphragm 202 has a disc shape, but it is not limited thereto. Diaphragm 202 may have another flat shape, such as a triangular or squire shape. However, the flat shape is preferably an asymmetric shape in order to obtain flat frequency characteristics by dispersing resonance generated in diaphragm 202. The asymmetric shape of diaphragms 202 is a shape which does not completely overlap the shape after rotated by 180° about the center of magnetostrictive element 12 (i.e. central axis 6001A).

Upper surface 203C of plate spring 203 has flat periphery 203B and concave center portion 203A surrounded by periphery 203B. Periphery 203B is coupled to lower surface 202B of diaphragm 202. Center portion 203A of upper surface 203C of plate spring 203 urges lower surface 18B of lower yoke 18 toward diaphragm 202. Periphery 203B of upper surface 203C of plate spring 203 is bonded to lower surface 202B of diaphragm 202 with an adhesive applied thereto

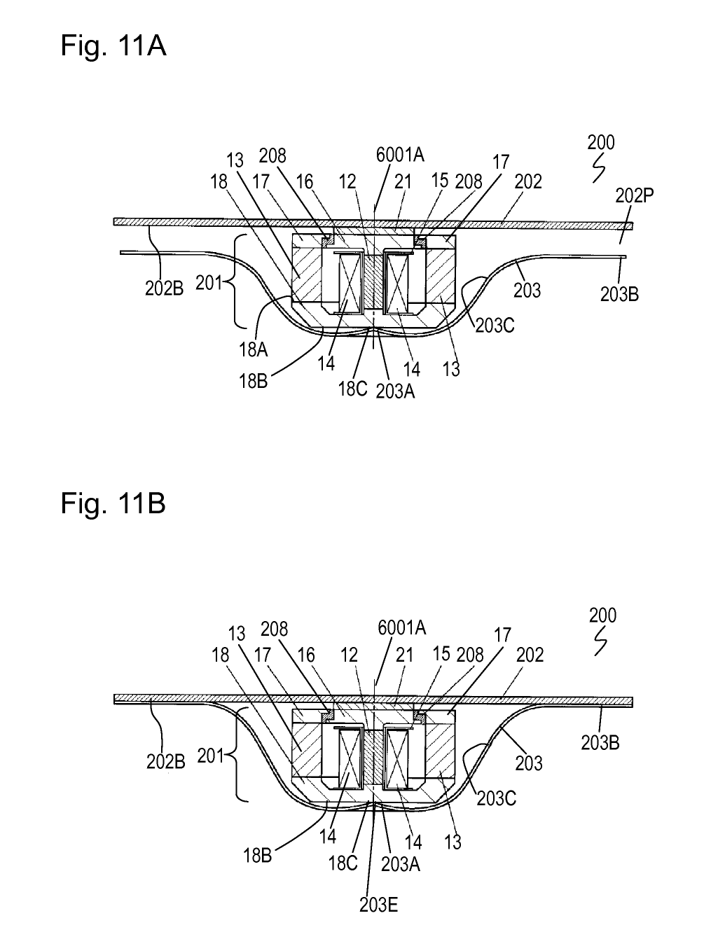

FIG. 11A is a sectional view showing magnetostrictive loudspeaker 200 before the bonding process of diaphragm 202 and plate spring 203. FIG. 11B is a sectional view showing magnetostrictive loudspeaker 200 after the bonding process of diaphragm 202 and plate spring 203. Before the bonding process, as shown in FIG. 11A, center portion 203A of upper surface 203C of plate spring 203 contacts lower surface 18B of lower yoke 18 but applies no force to lower surface 18B. Diaphragm 202 and periphery 203B of upper surface 203C of plate spring 203 have clearance 202P therebetween. In the bonding process, periphery 203B of plate spring 203 is upwardly pulled toward diaphragm 202, and flat periphery 203B of upper surface 203C of plate spring 203 is bonded to lower surface 202B of diaphragm 202, as shown in FIG. 11B. Once plate spring 203 is bonded to diaphragm 202, resilience of spring 203 keeps applying a compressive stress on lower yoke 18 of actuator 201 toward diaphragm 202.

Center portion 203A of upper surface 203C of plate spring 203 has projection 203E projecting therefrom upward toward magnetostrictive actuator 201, projection 203E locally contacts part 18C of lower surface 18B of lower yoke 18. Part 18C of lower surface 18B is opposite to magnetostrictive element 12. The periphery of part 18C on lower surface 18B is located away from plate spring 203. The structure above decreases the contact area between center portion 203A and lower yoke 18, creating an appropriate compressive stress with a small force. That is, the structure suppresses distortion of plate spring 203 beyond limitations of elastic deformation of plate spring 203.

In response to an AC signal applied to voice coil 14 from outside, magnetostrictive element 12 changes in shape in axial direction 6001B. At this moment, the AC signal applied to voice coil 14 is properly controlled so as to sufficiently prevent the shape of magnetostrictive element 12 from changing beyond limitations of elastic deformation of plate spring 203. Besides, magnet 13 applies a bias magnetic field to magnetostrictive element 12. According to the AC current, magnetostrictive element 12 expands and is compressed to vibrate diaphragm 202 to output sound. As described above, center portion 203A of upper surface 203C of plate spring 203 makes contact with lower surface 18B of lower yoke 18 with a small area of projection 203E and part 18C. This allows magnetostrictive element 12 of magnetostrictive actuator 201 to have a large compressive stress, increasing amount of magnetostrictive change in shape of element 12. As a result, diaphragm 202 of magnetostrictive loudspeaker 200 vibrates with a large stroke, producing large sound.

Center portion 203A of upper surface 203C of plate spring 203 does not necessarily have projection 203E. When plate spring 203 has no projection at center portion 203A, plate spring 203 contacts the entire area of lower surface 18B of lower yoke 18 and applies a pressure to magnetostrictive actuator 201.

In magnetostrictive loudspeaker 200, magnetostrictive actuator 201 is sealed in diaphragm 202 and plate spring 203 that are made of metal or resin. The closed structure protects magnetostrictive actuator 201 from dust, water, and inappropriate temperatures under a harsh domestic environment, preventing damages that can be caused in long-term use. That is, the structure enhances not only acoustic performance of magnetostrictive loudspeaker 200 but also durability thereof. In particular, it is suitable for applying audio guidance functions to home electric appliances that are prone to be affected by dust, water, and temperatures.

### Exemplary Embodiment 9

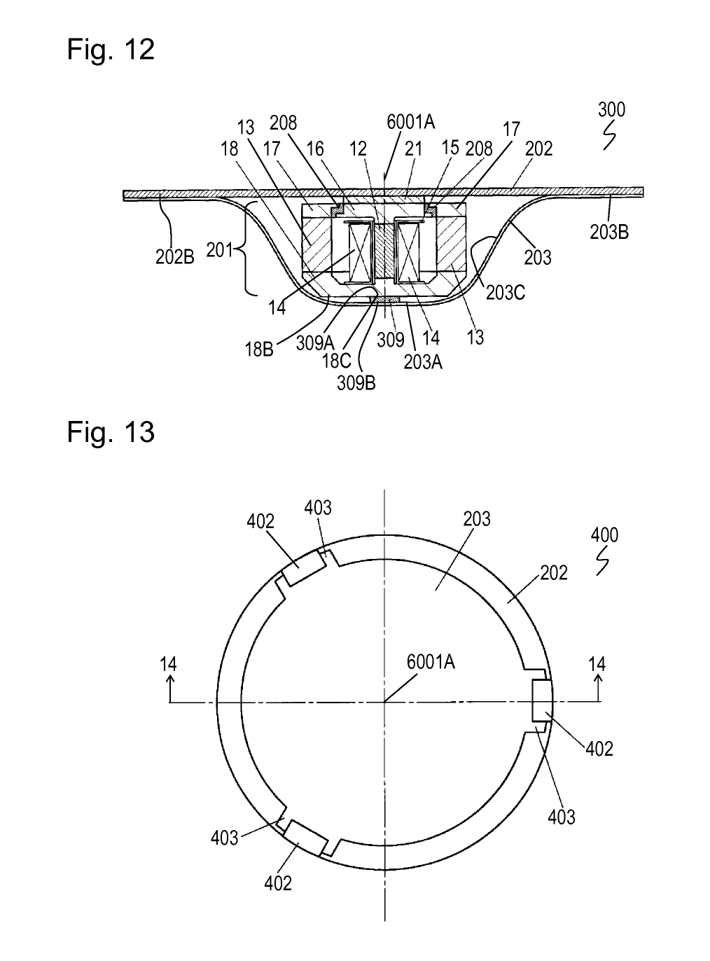

FIG. 12 is a sectional view showing magnetostrictive loudspeaker 300 in accordance with a ninth exemplary embodiment of the present invention. In FIG. 12, like parts are identified by the same reference marks as magnetostrictive speaker 200 of the eighth embodiment shown in FIGS. 8 through 11B.

In addition to the structure of magnetostrictive loudspeaker 200 of the eighth embodiment, magnetostrictive loudspeaker 300 further includes cushion 309 made of elastic material. Loudspeaker 300 does not have projection 203E at center portion 203A of upper surface 203C. Upper surface 309A of cushion 309 is joined to part 18C of lower surface 18B of lower yoke 18. Part 18C of lower surface 18B is positioned opposite to magnetostrictive element 12. Lower surface 309B of cushion 309 is joined to center portion 203A of plate spring 203. Resilience of plate spring 203 upwardly urges magnetostrictive actuator 201 via cushion 309 toward diaphragm 202. Like projection 203E of magnetostrictive loudspeaker 200 of the eighth embodiment, cushion 309 applies a pressure locally to part 18C of lower surface 18B of lower yoke 18 which is positioned opposite to magnetostrictive element 12. With the structure above, a certain type of plate spring 203 can be widely employed for magnetostrictive actuator 201 with difference in thickness by changing the thickness of cushion 309 in axial direction 6001B. That is, the structure expands the versatility of parts.

### Exemplary Embodiment 10

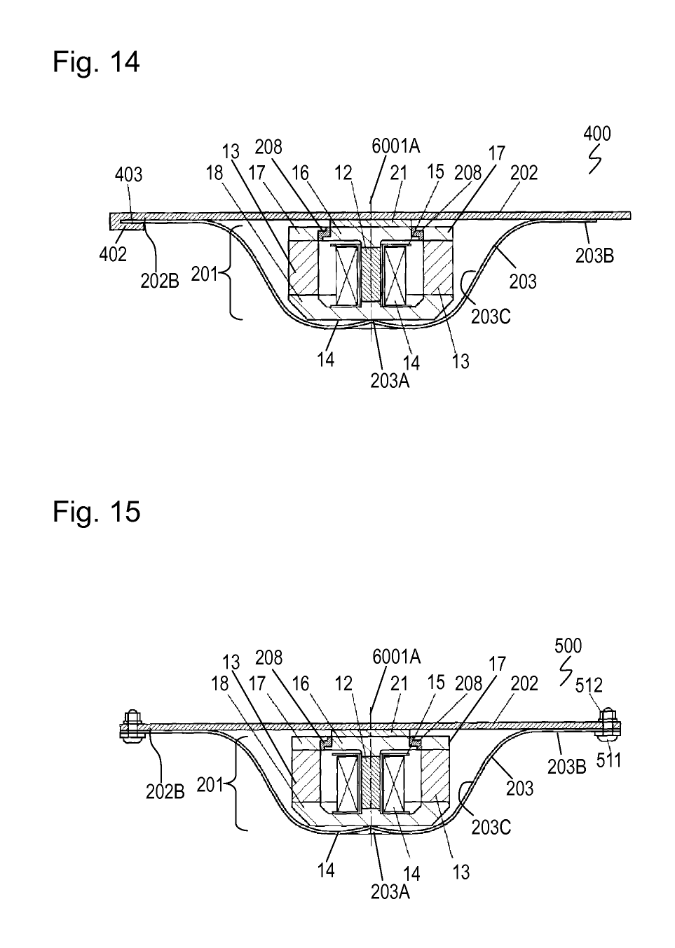

FIG. 13 is a top view showing magnetostrictive loudspeaker 400 in accordance with a tenth exemplary embodiment of the present invention. FIG. 14 is a sectional view showing the magnetostrictive loudspeaker along line 14-14 shown in FIG. 13. In FIGS. 13 and 14, like parts are identified by the same reference marks as magnetostrictive speaker 200 of the eighth embodiment shown in FIGS. 8 to 11B.

Diaphragm 202 of magnetostrictive loudspeaker 400 has a plurality of clamps 402. Plate spring 203 has a plurality of projections 403 protruding from periphery 203B. Plate spring 203 is fixed to diaphragm 202 by engagement of clamps 402 with projections 403.

A procedure of assembling fix plate spring 203 to diaphragm 202 will be described below. First, each projection 403 of plate spring 203 is located on lower surface 202B at a part having no clamp 402. Next, plate spring 203 is rotated about central axis 6001A with respect to diaphragm 202 so as to put projections 403 under clamps 402. After that, projections 403 are bonded to clamps 402 with adhesive. In this way, diaphragm 202 is joined mechanically to plate spring 203. The structure has a bonding strength greater than that bonded with adhesive alone.

Projections 403 and clamps 402 are preferably disposed at the peripheries of plate spring 203 and diaphragm 202, respectively, so as to be equiangularly spaced about central axis 6001A. Such an arrangement allows plate spring 203 and diaphragm 202 to be not only easily fixed but also protected from damage.

### Exemplary Embodiment 11

FIG. 15 is a sectional view showing magnetostrictive loudspeaker 500 in accordance with an eleventh exemplary embodiment of the present invention. In FIG. 15, like parts are identified by the same reference marks as magnetostrictive speaker 200 of the eighth embodiment shown in FIGS. 8 to 11B.

In the periphery of diaphragm 202 and in periphery 203B of plate spring 203, a plurality of holes is formed for screws 511 and nuts 512. Plate spring 203 is fixed to diaphragm 202 with screws 511 and nuts 512. This structure above joins mechanically diaphragm 202 to plate spring 203 with a greater strength than adhesive.

### Exemplary Embodiment 12

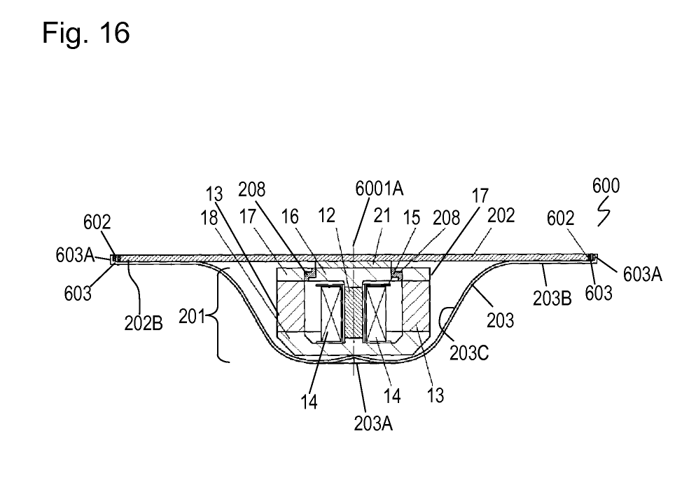

FIG. 16 is a sectional view showing magnetostrictive loudspeaker 600 in accordance with a twelfth exemplary embodiment of the present invention. In FIG. 16, like parts are identified by the same reference marks as magnetostrictive speaker 200 of the eighth embodiment shown in FIGS. 8 to 11B.

Diaphragm 202 has male screw section 602 provided entirely on the periphery of diaphragm 202. Plate spring 203 has projection 603A protruding upwardly from the brim of periphery 203B of upper surface 203C. Projection 603A has female screw section 603 on its inner side. Plate spring 203 is fixed to diaphragm 202 by engagement of male screw section 602 of diaphragm 202 and female screw section 603 of plate spring 203. This structure above mechanically joins diaphragm 202 to plate spring 203 with a greater strength than adhesive.

### Exemplary Embodiment 13

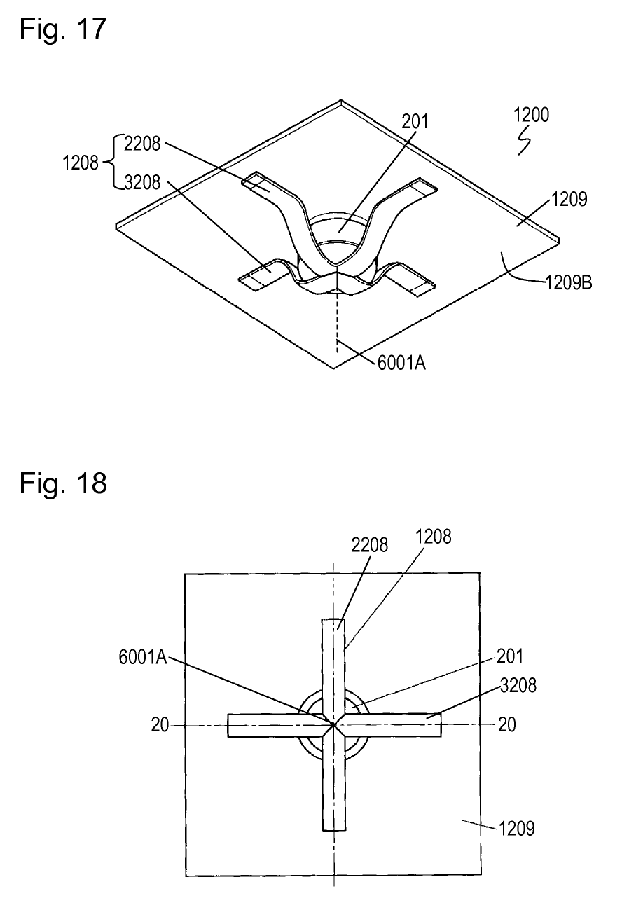

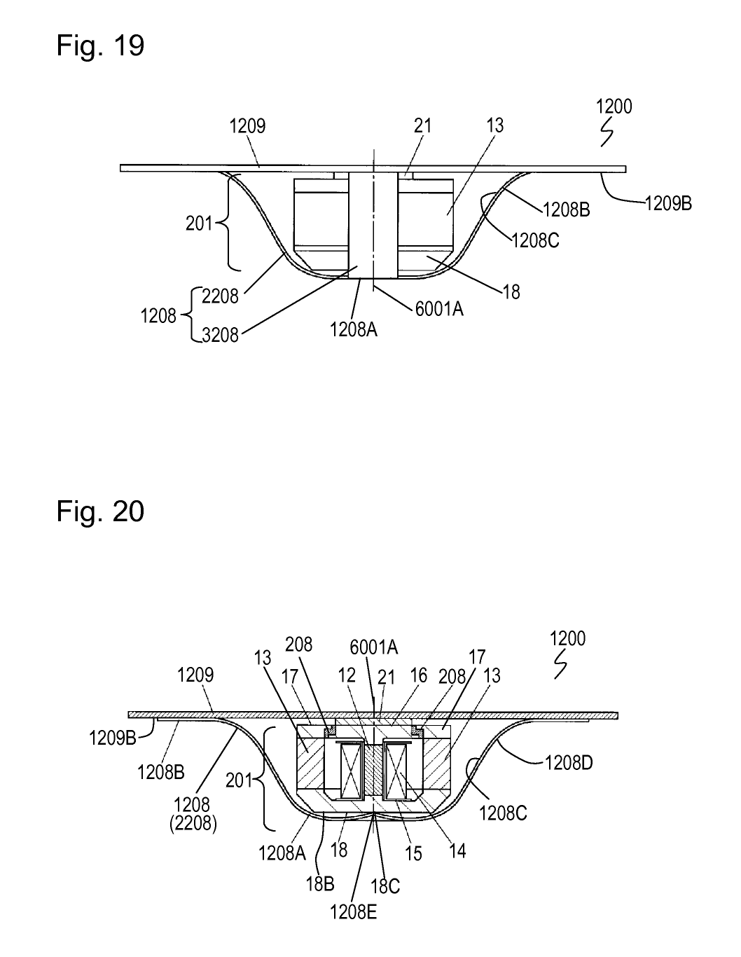

FIGS. 17, 18, and 19 are a perspective view, a plan view, and a side view, respectively, of magnetostrictive loudspeaker 1200 in accordance with a thirteenth exemplary embodiment of the present invention. FIG. 20 is a sectional view of magnetostrictive loudspeaker 1200 along line 20-20 shown in FIG. 18. In FIGS. 17 to 20, like parts are identified by the same reference marks as magnetostrictive speaker 200 of the eighth embodiment shown in FIGS. 8 to 10. Magnetostrictive loudspeaker 1200 of the thirteenth embodiment has diaphragm 1209 and plate spring 1208 as an elastic body. Diaphragm 1209 and plate spring 1208 correspond to diaphragm 202 and plate spring 203, respectively, of magnetostrictive loudspeaker 200 of the eighth embodiment shown in FIGS. 8 to 10. Diaphragm 1209 converts vibration generated in movable section 16 into sound.

Plate spring 1208 has spring strips 2208 and 3208 joined to each other at central axis 6001A. Spring strips 2208 and 3208 equiangularly extend about central axis 6001A. Plate spring 1208 (spring strips 2208 and 3208) has a structure similar to plate spring 203 of magnetostrictive loudspeaker 200 of the eighth embodiment; upper surface 1208C of plate spring 1208 has flat periphery 1208B and concave center portion 1208A surrounded by periphery 1208B. Periphery 1208B is joined to lower surface 1209B of diaphragm 1209. Center portion 1208A of upper surface 1208C of plate spring 1208 urges lower surface 18B of lower yoke 18 toward diaphragm 1209. Periphery 1208B of upper surface 1208C of plate spring 1208 is bonded to lower surface 1209B of diaphragm 1209 with adhesive applied thereto.

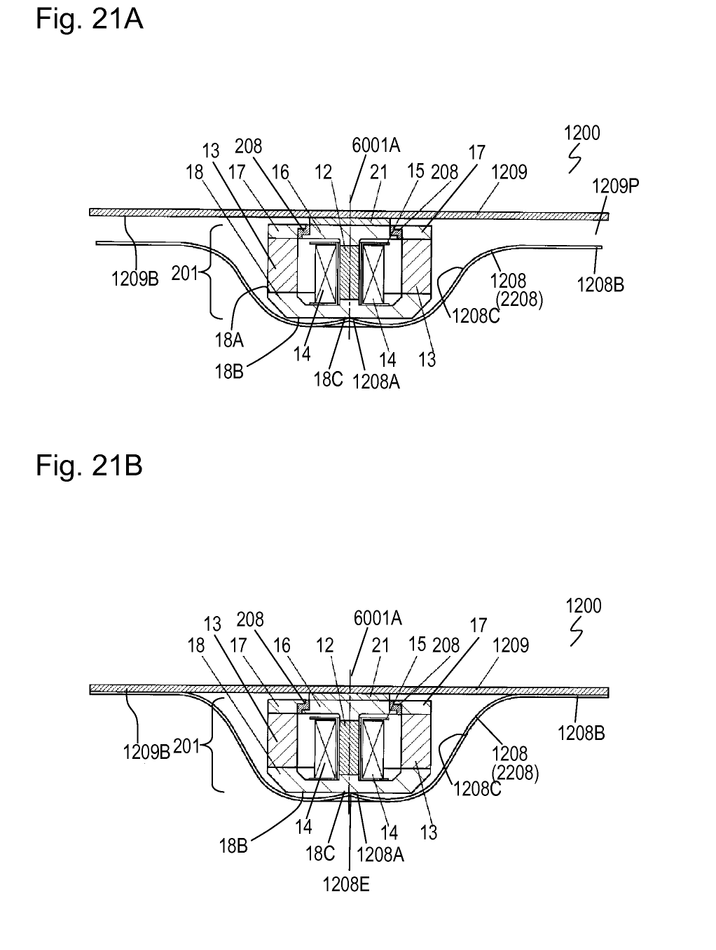

FIG. 21A is a sectional view showing magnetostrictive loudspeaker 1200 before the bonding process of diaphragm 1209 and plate spring 1208. FIG. 21B is a sectional view showing magnetostrictive loudspeaker 1200 after the bonding process of diaphragm 1209 and plate spring 1208. Before the bonding process, as shown in FIG. 21A, center portion 1208A of upper surface 1208C of plate spring 1208 contacts lower surface 18B of lower yoke 18 but applies no force thereon. Diaphragm 1209 and periphery 1208B of upper surface 1208C of plate spring 1208 have clearance 1209P therebetween. In the bonding process, periphery 1208B of plate spring 1208 is upwardly pulled toward diaphragm 1209, and flat periphery 1208B of upper surface 1208C of plate spring 1208 is bonded to lower surface 1209B of diaphragm 1209, as shown in FIG. 21B. Once plate spring 1208 is bonded to diaphragm 1209, resilience of spring 1208 keeps applying a compressive stress on lower yoke 18 of actuator 201 toward diaphragm 1209.

Center portion 1208A of upper surface 1208C of plate spring 1208 (i.e. spring strips 2208 and 3208) has projection 1208E projecting toward magnetostrictive actuator 201. Projection 1208E locally contacts part 18C of lower surface 18B of lower yoke 18. Part 18C of lower surface 18B is positioned opposite to magnetostrictive element 12. The periphery of part 18C on lower surface 18B is located away from plate spring 1208. The structure above decreases the contact area between center portion 1208A and lower yoke 18, creating an appropriate compressive stress with a small force. That is, the structure suppresses distortion of plate spring 1208 beyond limitations of elastic deformation of plate spring 1208.

Center portion 1208A of upper surface 1208C of plate spring 1208 does not necessarily have projection 1208E. When plate spring 1208 has no projection at center portion 1208A, plate spring 1208 contacts the entire area of lower surface 18B of lower yoke 18 and applies a pressure on magnetostrictive actuator 201.

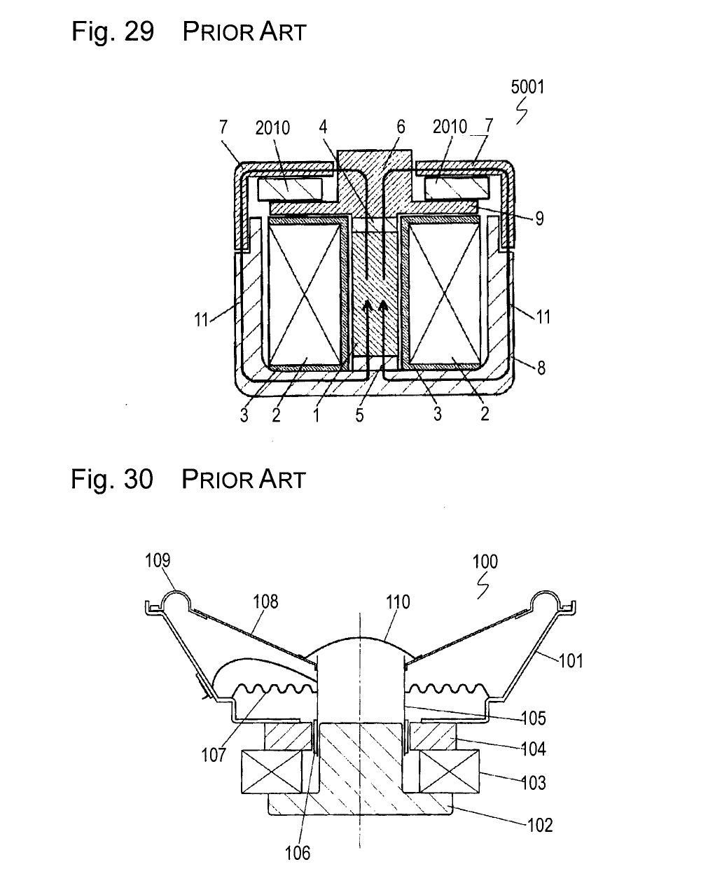

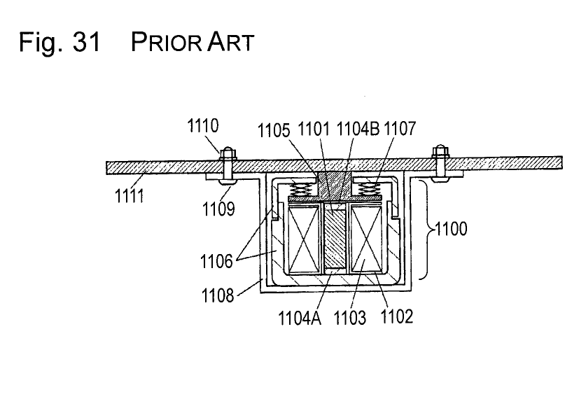

As described above, plate spring 1208 (i.e. spring strips 2208 and 3208) urges magnetostrictive actuator 201 toward diaphragm 1209 to continuously apply a large compressive stress to magnetostrictive actuator 201. This increases amount of the change in the shape of magnetostrictive element 12. As a result, diaphragm 1209 of magnetostrictive loudspeaker 1200 vibrates with a large stroke, producing large sound. Magnetostrictive actuator 201 has a structure thinner than conventional actuator 5001 (FIG. 29) having a spring therein, producing sound as powerful as that offered by the conventional structure.

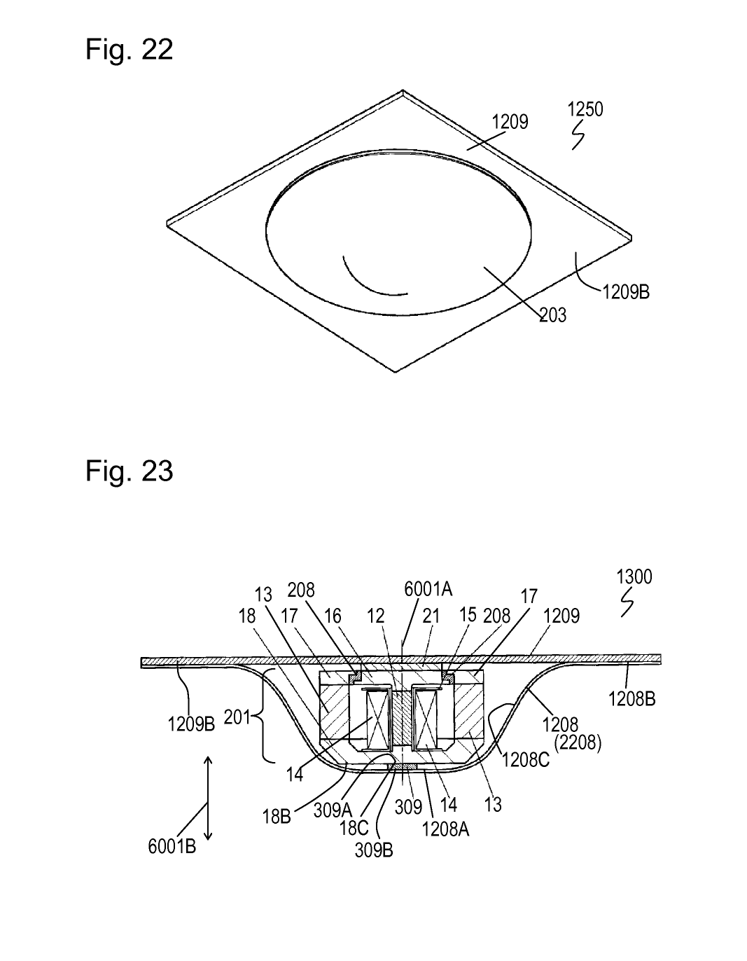

FIG. 22 is a perspective view showing magnetostrictive actuator 1250 as another structure in accordance with the thirteenth embodiment. In FIG. 22, like parts are identified by the same reference marks as magnetostrictive speaker 1200 shown in FIGS. 17 to 21B. Instead of plate spring 1208 of magnetostrictive loudspeaker 1200 shown in FIG. 17, magnetostrictive loudspeaker 1250 has plate spring 203 in according with the eighth embodiment. Magnetostrictive actuator 201 is sealed with diaphragm 1209 and plate spring 203. The closed structure protects magnetostrictive actuator 201 from dust, water, and inappropriate temperatures under a harsh domestic environment, preventing damages that can be caused in long-term use.

### Exemplary Embodiment 14

FIG. 23 is a sectional view showing magnetostrictive loudspeaker 1300 in accordance with a fourteenth exemplary embodiment of the present invention. In FIG. 23, like parts are identified by the same reference marks as magnetostrictive speaker 1200 of the 13th embodiment shown in FIGS. 17 to 21B.

In addition to the structure of magnetostrictive loudspeaker 1200 of the thirteenth embodiment, magnetostrictive loudspeaker 1300 further has cushion 309 made of elastic material. Loudspeaker 1300 does not have projection 1208E at center portion 1208A of upper surface 1208C. Upper surface 309A of cushion 309 is joined to part 18C of lower surface 18B of lower yoke 18. Part 18C of lower surface 18B is positioned opposite to magnetostrictive element 12. Lower surface 309B of cushion 309 is joined to center portion 1208A of plate spring 1208. Resilience of plate spring 1208 upwardly urges magnetostrictive actuator 201 via cushion 309 toward diaphragm 1209. Like projection 1208E of magnetostrictive loudspeaker 1200 of the thirteenth embodiment, cushion 309 applies a pressure locally to part 18C of lower surface 18B of lower yoke 18 which is positioned opposite to magnetostrictive element 12. With the structure above, a certain type of plate spring 203 can be widely employed for magnetostrictive actuator 201 with difference by changing the thickness of cushion 309 in axial direction 6001B. The structure expands the versatility of parts.

### Exemplary Embodiment 15

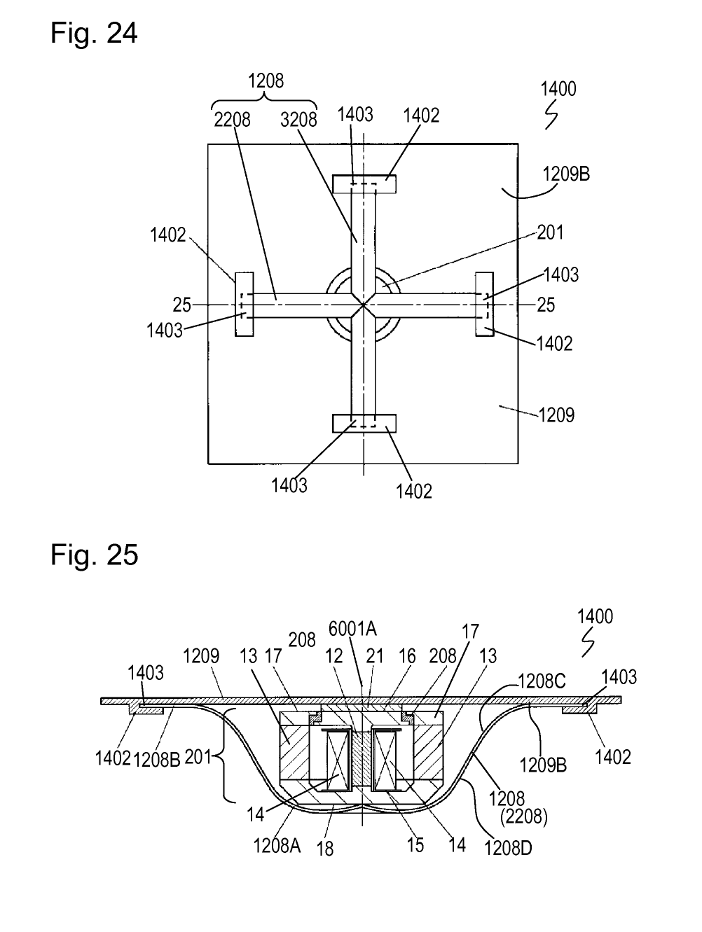

FIG. 24 is a plan view showing magnetostrictive loudspeaker 1400 in accordance with a fifteenth exemplary embodiment of the present invention. FIG. 25 is a sectional view of magnetostrictive loudspeaker 1400 along line 25-25 shown in FIG. 24. In FIGS. 24 and 25, like parts are identified by the same reference marks as magnetostrictive speaker 1200 of the 13th embodiment shown in FIGS. 17 to 21B.

Diaphragm 1209 of magnetostrictive loudspeaker 1400 has a plurality of clamps 1402. Plate spring 1208 is fixed to diaphragm 1209 by engagement of clamps 402 with each end of spring strips 2208 and 3208 of plate spring 1208.

A procedure for assembling plate spring 1208 to diaphragm 1209 will be described below. First, each strip end 1403 of plate spring 1208 is located on lower surface 1209B at a part having no clamp 1402. Next, plate spring 1208 is rotated about central axis 6001A with respect to diaphragm 1209 so as to put each strip end 1403 under clamp 1402. After that, strip end 1403 is bonded to clamp 1402 with adhesive. In this way, diaphragm 1209 is joined mechanically to plate spring 1208 with a greater strength than that bonded with adhesive alone.

### Exemplary Embodiment 16

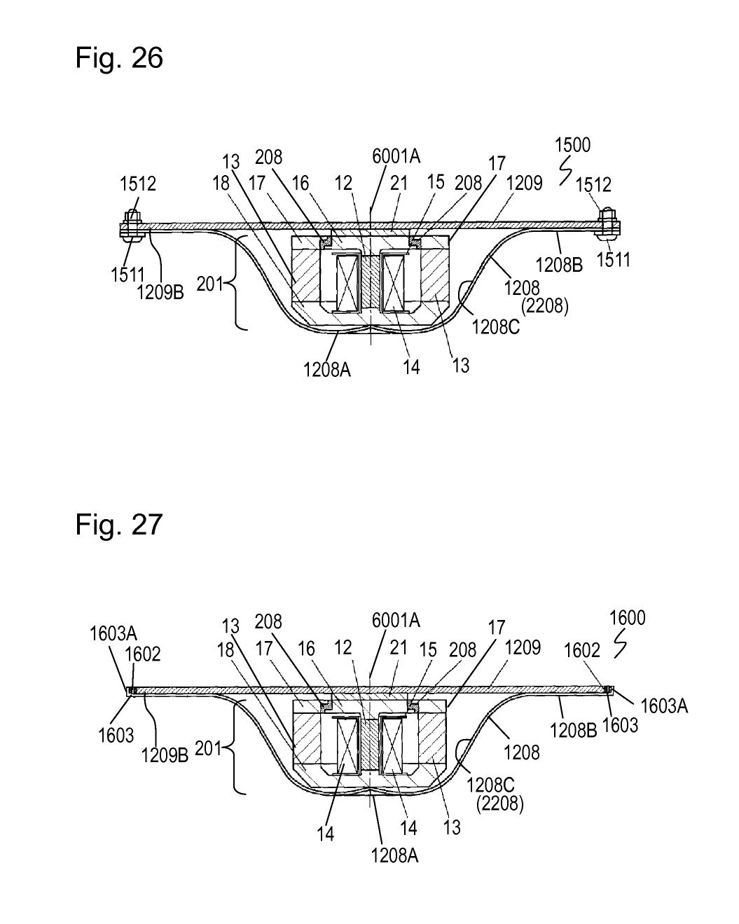

FIG. 26 is a sectional view showing magnetostrictive loudspeaker 1500 in accordance with a sixteenth exemplary embodiment of the present invention. In FIG. 26, like parts are identified by the same reference marks as magnetostrictive speaker 1200 of the 13th embodiment shown in FIGS. 17 to 21B.

In the periphery of diaphragm 1209 and in periphery 1208B of plate spring 1208, a plurality of holes is formed for screws 1511 and nuts 1512. Plate spring 1208 is fixed to diaphragm 1209 with screws 1511 and nuts 1512. With the structure above, diaphragm 1209 is mechanically joined to plate spring 1208 with a bonding strength greater than the structure bonded with adhesive.

### Exemplary Embodiment 17

FIG. 27 is a sectional view showing magnetostrictive loudspeaker 1600 in accordance with a seventeenth exemplary embodiment of the present invention. In FIG. 27, like parts are identified by the same reference marks as magnetostrictive speaker 1200 of the 13th embodiment shown in FIGS. 17 to 21B.

Diaphragm 1209 has male screw section 1602 provided entirely on the periphery of diaphragm 1209. Plate spring 1208 has projection 1603A protruding upwardly from the brim of periphery 1208B of upper surface 1208C. Projection 1603A has female screw section 1603 on its inner side. Plate spring 1208 is fixed to diaphragm 1209 by engagement of male screw section 1602 of diaphragm 1209 and female screw section 1603 of plate spring 1208. This structure above mechanically joins diaphragm 1209 to plate spring 1208 with a strength greater than adhesive.

### Exemplary Embodiment 18

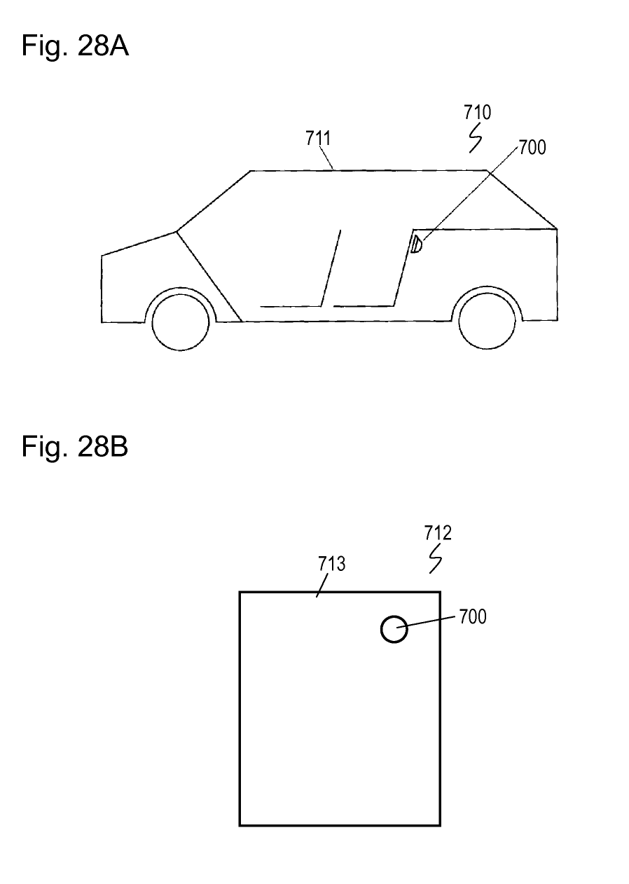

FIG. 28A is a sectional view showing car 710 as a device having magnetostrictive loudspeaker 700 in accordance with exemplary an eighteenth embodiment of the present invention. Magnetostrictive loudspeaker 700 employed here is any one of the magnetostrictive loudspeakers in accordance with the eighth to seventeenth embodiments. In car 710 of the eighteenth embodiment, magnetostrictive loudspeaker 700 is built in a headrest of the rear seat of car body 711 as a chassis, but it is not limited to; loudspeaker 700 can be built in a headrest of the front seats, the doors, the center console, or the instrument panel.

FIG. 28B is a sectional view showing another device 712 having magnetostrictive loudspeaker 700 in accordance with the eighteenth embodiment.

Device 712 has magnetostrictive loudspeaker 700 and housing 713 to which loudspeaker 700 is mounted. Device 712 is, for example, a home electric appliance, such as a rice cooker, a refrigerator, or a washing machine. Magnetostrictive loudspeaker 700 reproduces sound in wide range of use, and accordingly, the structure of the loudspeaker enables audio guidance functions to be added to devices, such as cars and home electric appliances, which work under a harsh environment. Diaphragm 1209 may be building materials, such as ceiling materials and wall materials of houses. In that case, magnetostrictive actuator 201 vibrates the building material as the diaphragm, so that magnetostrictive loudspeaker 700 reproduces sound. Further, diaphragm 1209 may be housing 713 itself of an electric appliance, such as a rice cooker, a refrigerator, or a washing machine. In this case, magnetostrictive actuator 201 vibrates housing 713 as the diaphragm, so that magnetostrictive loudspeaker 700 reproduces sound.

Magnetostrictive actuators and magnetostrictive loudspeakers in accordance with the thirteenth to seventeenth embodiments do not necessarily have vibration-transmitting member 21 between the diaphragm and upper surface 16A of movable section 16. In the structure without vibration-transmitting member 21, upper surface 16A of movable section 16 is directly joined to the diaphragm.

Magnetostrictive actuator 201 in accordance with the eighth to eighteenth embodiment is replaceable with any one of the magnetostrictive actuator in accordance with the first to seventh embodiment. Any one of them provides similar effects.

Throughout the embodiments, terms, such as “upper yoke”, “lower yoke”, “upper surface”, “lower surface”, “upper end”, “lower end”, “upwardly”, and “downwardly”, indicating directions indicate relative directions depending on relative positional relationship of components, such as the magnetostrictive element, the magnet, and the yoke, of the mangetostrictive actuator, and do not indicate absolute directions, such as a vertical direction. For example, when diaphragm 1209 is a wall having a vertical wall surface, lower surface 1209B of diaphragm 1209 extend in the vertical direction, and central axis 6001A extends in the horizontal direction. When diaphragm 1209 is a ceiling material, lower surface 1209B of diaphragm 1209 is faces upward.

### INDUSTRIAL APPLICABILITY

A magnetostrictive actuator of the present invention has a low-profile structure and suppresses undesired vibration. The excellent linearity of the structure allows the actuator to be easily disposed in a limited space. That is, the actuator is suitable not only for a panel loudspeaker that reproduces sound but also audio equipment to be mounted on audio-video (AV) equipment, such as television sets.

### REFERENCE MARKS IN THE DRAWINGS

12 Magnetostrictive Element
13 Magnet
14 Voice Coil
15 Bobbin
16 Movable Section
16E Groove
16F Flange (First Flange)
17 Upper Yoke
17E Groove
17F Flange (Second Flange)
18 Lower Yoke
19 Elastic Member
20 O-Ring
21 Vibration-Transmitting Member
22 Recess
23 Recess
24 Resin Film
202 Diaphragm
203 Plate Spring (Elastic Body)
203A Center portion
203B Periphery
713 Housing
1208 Plate Spring (Elastic Body)
1208A Center Portion
1208B Periphery
1209 Diaphragm
6001A Central Axis
6001E Clearance

1. A magnetostrictive actuator comprising:
a magnetostrictive element extending along a central axis, the element having an upper surface, a lower surface arranged opposite to the upper surface in a direction of the central axis, and a side surface extending in the direction of the central axis;
a movable section displaced in response to a change of a shape of the magnetostrictive element, wherein the movable section has a lower surface fixed to the upper surface of the magnetostrictive element, an upper surface opposite to the lower surface, and an outside surface;
a voice coil wound about the magnetostrictive element;
a magnet surrounding the magnetostrictive element and the voice coil;
a lower yoke having an upper surface coupled to a lower surface of the magnet and the lower surface of the magnetostrictive element;
an upper yoke having a lower surface and an inside surface, the lower surface of the upper yoke being coupled to an upper surface of the magnet, the inside surface of the upper yoke facing the outside surface of the movable section across a clearance; and
an elastic member disposed in the clearance, the elastic member being coupled to the outside surface of the movable section and the inside surface of the upper yoke.

2. The magnetostrictive actuator of claim 1, wherein the clearance flares upwardly.

3. The magnetostrictive actuator of claim 1, wherein the elastic member is an adhesive applied in the clearance.

4. The magnetostrictive actuator of claim 1, wherein the outside surface of the movable section and the inside surface of the upper yoke have grooves provided therein, respectively, and the elastic member is an O-ring fitted in the grooves.

5. The magnetostrictive actuator of claim 1, wherein
the movable section includes a first flange extending from an upper end of the outside surface of the movable section toward the inside surface of the upper yoke,
the upper yoke includes a second flange extending from a lower end of the outside surface of the upper yoke toward the outside surface of the movable section, and
the elastic member is surrounded by the outside surface of the movable section, the inside surface of the upper yoke, the first flange, and the second flange.

6. The magnetostrictive actuator of claim 1, wherein
the movable section includes a first flange extending from a lower end of the outside surface of the movable section toward the inside surface of the upper yoke,
the upper yoke includes a second flange extending from an upper end of the outside surface of the upper yoke toward the outside surface of the movable section, and
the elastic member is surrounded by the outside surface of the movable section, the inside surface of the upper yoke, the first flange, and the second flange.

7. The magnetostrictive actuator of claim 1, wherein a thickness of the magnet in the direction of the central axis is identical to a thickness of the magnetostrictive element in the direction of the central axis.

8. The magnetostrictive actuator of claim 1, wherein the magnet has a cylindrical shape extending along the central axis.

9. The magnetostrictive actuator of claim 1, wherein the lower surface of the movable section has a recess provided therein, and the upper surface of the magnetostrictive element is fitted in the recess.

10. The magnetostrictive actuator of claim 1, wherein the upper surface of the lower yoke has a recess provided therein, and the lower surface of the magnetostrictive element is fitted in the recess.

11. The magnetostrictive actuator of claim 1, further comprising a vibration-transmitting member joined to the upper surface of the movable section, wherein the vibration-transmitting member differs in a material property from the movable section.

12. The magnetostrictive actuator of claim 1, further comprising
a bobbin made of resin about which the voice coil is wound, the bobbin surrounding the side surface of the magnetostrictive element, wherein
the magnetostrictive element is formed in the bobbin by insert molding.

13. The magnetostrictive actuator of claim 1, further comprising a resin film entirely covering the movable section, the magnet, the lower yoke, the upper yoke, and the elastic member.

14. The magnetostrictive actuator of claim 1, wherein the upper surface of the movable section is to be coupled to a lower surface of a diaphragm, the magnetostrictive actuator further comprising
an elastic body that urges the movable section toward the diaphragm, the elastic body having a center portion and a periphery, the center portion of the elastic body contacting the lower yoke, the periphery of the elastic body being joined to the lower surface of the diaphragm.

15. The magnetostrictive actuator of claim 14, wherein the elastic body is a plate spring.

16. The magnetostrictive actuator of claim 14, wherein the magnetostrictive actuator is to be sealed with the diaphragm and the elastic body.

17. The magnetostrictive actuator of claim 14, further comprising a vibration-transmitting member having an upper surface and a lower surface, the upper surface of the vibration-transmitting member being to be joined to the lower surface of the diaphragm, the lower surface of the vibration-transmitting member being joined to the upper surface of the movable section.

18. The magnetostrictive actuator of claim 1, wherein the magnetostrictive element is a super magnetostrictive element.

19. A magnetostrictive actuator comprising:
a magnetostrictive element;
a movable section to be joined to a diaphragm, the movable section being displaced in response to a change of a shape of the magnetostrictive element;
a voice coil that applies a magnetic field to the magnetostrictive element;
a magnet that applies a magnetic field to the magnetostrictive element;
a yoke that constitutes a magnetic circuit together with the magnetostrictive element and the magnet; and
an elastic body that urges the movable section toward the diaphragm.

20. A magnetostrictive loudspeaker comprising:
a magnetostrictive actuator that generates a vibration by a magnetostriction phenomenon;
a diaphragm for converting the vibration into sound, the diaphragm having a lower surface joined to an upper surface of the magnetostrictive actuator; and
an elastic body that urges the magnetostrictive actuator toward the diaphragm, the elastic body having a center portion and a periphery, wherein
the center portion of the elastic body contacts the magnetostrictive actuator, and the periphery of the elastic body is joined to the lower surface of the diaphragm.

21. The magnetostrictive loudspeaker of claim 20, wherein the magnetostrictive actuator is sealed with the elastic body and the diaphragm.

22. The magnetostrictive loudspeaker of claim 20, wherein the magnetostrictive actuator comprises:
a magnetostrictive element extending along a central axis, the element having an upper surface, a lower surface opposite to the upper surface in a direction of the central axis, and a side surface extending in the direction of the central axis;
a movable section displaced in response to a change of a shape of the magnetostrictive element to generate the vibration, the movable section having a lower surface fixed to the upper surface of the magnetostrictive element, an upper surface opposite to the lower surface, and an outside surface;
a voice coil wound about the magnetostrictive element;
a magnet surrounding the magnetostrictive element and the voice coil;
a lower yoke having an upper surface coupled to a lower surface of the magnet and the lower surface of the magnetostrictive element;
an upper yoke having a lower surface and an inside surface, the lower surface of the upper yoke being coupled to an upper surface of the magnet, the inside surface of the upper yoke facing the outside surface of the movable section across a clearance; and
an elastic member disposed in the clearance, the elastic member being coupled to the outside surface of the movable section and the inside surface of the upper yoke.

23. The magnetostrictive loudspeaker of claim 22, further comprising a vibration-transmitting member having an upper surface and a lower surface, the upper surface of the vibration-transmitting member being joined to the lower surface of the diaphragm, the lower surface of the vibration-transmitting member being joined to the upper surface of the movable section.

24. The magnetostrictive loudspeaker of claim 22, wherein the magnetostrictive element is a super magnetostrictive element that vibrates by a super magnetostriction phenomenon.

25. The magnetostrictive loudspeaker of claim 20, wherein the elastic body is a plate spring.

26. A device comprising:
the magnetostrictive loudspeaker of claim 20; and
a housing having the magnetostrictive loudspeaker mounted thereto.

27. The device of claim 26, wherein the housing functions as the diaphragm.
